(19) United States
(12) Patent Application Publication
(10) Pub. No.: US 2023/0272208 A1
(43) Pub. Date: Aug. 31, 2023

(54) POLYMER BLENDS OF ALIPHATIC POLYKETONE, ACRYLONITRILE BUTADIENE STYRENE, AND FLAME RETARDANT

(71) Applicant: Avient Corporation, Avon Lake, OH (US)

(72) Inventors: Zachary Zander, Lake Geneva, WI (US); John Swanson, Lakewood, OH (US)

(73) Assignee: Avient Corporation, Avon Lake, OH (US)

(21) Appl. No.: 18/023,710

(22) PCT Filed: Aug. 26, 2021
(86) PCT No.: PCT/US21/47747

§ 371 Date: Feb. 27, 2023

Related U.S. Application Data
(60) Provisional application No. 63/071,833, filed on Aug. 28, 2020.

(51) Int. Cl. C08L 61/02

(52) U.S. Cl. CPC C08L 61/02; C08L 2205/03

(57) ABSTRACT

Embodiments of the present disclosure are directed to polymer blends comprising greater than or equal to 45 wt % and less than or equal to 90 wt % of an aliphatic polyketone; greater than or equal to 7.5 wt % and less than or equal to 40 wt % of an acrylonitrile butadiene styrene (ABS); and greater than 0 wt % and less than or equal to 25 wt % of a flame retardant.

### CLAIM OF PRIORITY

This application claims the benefit of U.S. Provisional Patent Application Ser. No. 63/071,833 bearing Attorney Docket Number 12020008 and filed on Aug. 28, 2020, which is hereby incorporated by reference in its entirety.

### TECHNICAL FIELD

Embodiments of the present disclosure are generally related to polymer blends, and are specifically related to polymer blends of aliphatic polyketone, acrylonitrile butadiene styrene (ABS), and flame retardant having improved chemical resistance and flame retardancy.

### BACKGROUND

Polymer blends of acrylonitrile butadiene styrene (ABS) and polycarbonate (PC) are widely used, such as in healthcare, automotive, and electronic applications, due to their relatively high heat resistance and combination of tensile strength and toughness. ABS improves the processability and flexibility of the polymer blend, but its upper glass transition temperature of approximately 95 to 105° C. limits the ability to use the blend in high temperature applications. To balance out the ABS, PC is added to increase the heat resistance of the polymer blend.

While ABS imparts its resistance to aqueous solutions to the ABS and PC blend, ABS and PC blends have relatively poor chemical resistance, particularly towards organic solvents, hydrocarbons, and select alcohols, and may not be sufficient for certain applications in the healthcare, automotive, and electronic fields. Moreover, materials used for said applications may require a high level of flame resistance in addition to chemical resistance.

Accordingly, a continual need exists for improved polymer blends that exhibit the desired chemical resistance and flame retardancy while providing improved heat resistance and sufficient tensile and flexural strength and stiffness for the aforementioned applications.

### SUMMARY

Embodiments of the present disclosure are directed to polymer blends of aliphatic polyketone, ABS, and flame retardant, which meet the desired chemical resistance and flame retardancy while providing improved heat resistance and sufficient tensile and flexural strength and stiffness. Additionally, these polymer blends may exhibit sufficient impact strength.

According to one embodiment, a polymer blend is provided. The polymer blend comprises greater than or equal to 45 wt % and less than or equal to 90 wt % of an aliphatic polyketone; greater than or equal to 7.5 wt % and less than or equal to 40 wt % of an acrylonitrile butadiene styrene; and greater than 0 wt % and less than or equal to 25 wt % of a flame retardant.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DRAWINGS

FIG. 1 is a photograph of sample bars formed using example formulations in accordance with embodiments described herein in a strain jig.

### DETAILED DESCRIPTION

Reference will now be made in detail to various embodiments of polymer blends, specifically polymer blends comprising greater than or equal to 45 wt % and less than or equal to 90 wt % of an aliphatic polyketone; greater than or equal to 7.5 wt % and less than or equal to 40 wt % of an acrylonitrile butadiene styrene (ABS); and greater than 0 wt % and less than or equal to 25 wt % of a flame retardant.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The terms “0 wt %,” “free,” and “substantially free,” when used to describe the weight and/or absence of a particular component in a polymer blend means that the component is not intentionally added to the polymer blend. However, the polymer blend may contain traces of the component as a contaminant or tramp in amounts less than 0.05 wt %.

Weight Average Molecular Weight (Mw), as described herein, is measured using conventional gel permeation chromatography.

The term “wt %,” as described herein, refers to wt % based on the weight of the polymer blend, unless otherwise noted.

The term “heat deflection temperature,” as described herein, refers to the temperature at which an article formed from the polymer blend described herein deflects as measured according to ASTM D648 at a 0.45 MPa load.

The terms “tensile modulus” or “tensile stiffness,” as described herein, refer to the ratio of the stress along an axis over the strain along that axis as measured according to ASTM D638 at 23° C. and a rate of strain of 0.85 mm/s.

The term “yield,” as used herein, refers to the point on a stress-strain curve that indicates the limit of elastic behavior and the beginning of plastic behavior.

The term “tensile strength at yield,” as described herein, refers to the maximum stress that a material can withstand while being stretched before it begins to change shape permanently as measured according to ASTM D638 at 23° C. and a rate of strain of 0.85 mm/s.

The term “tensile elongation at yield,” as described herein, refers to the ratio between the increased length and initial length at the yield point as measured according to ASTM D638 at 23° C. and a rate of strain of 0.85 mm/s.

The term “tensile strength at break,” as described herein, refers to the maximum stress that a material can withstand while stretching before breaking as measured according to ASTM D638 at 23° C. and a rate of strain of 0.85 mm/s.

The term “tensile elongation at break,” as described herein, refers to the ratio between increased length and initial length after breakage as measured according to ASTM D638 at 23° C. and a rate of strain of 0.85 mm/s.

The terms “flexural modulus” or “flexural stiffness,” as described herein, refer the ratio of stress to strain in flexural deformation as measured according to ASTM D790 at 23° C. and a rate of strain 0.21 mm/s.

The term “flexural strength,” as described herein, refers to the maximum bending stress that may be applied to a material before it yields as measured according to ASTM D790 at 23° C. and a rate of strain 0.21 mm/s.

The term “sufficient tensile and flexural strength and stiffness,” as described herein, refers to a tensile modulus greater than or equal to 1600 MPa, a tensile strength at yield greater than or equal to 35 MPa, a tensile strength at break greater than or equal to 35 MPa, a flexural modulus greater than or equal to 1900 MPa, and a flexural strength greater than or equal to 5 MPa.

The term “melt flow rate,” as described herein, refers the ability of the material's melt to flow under pressure as measured according to ASTM D1238 at the given temperature and pressure applied by the given weight.

The term “Notched Izod Impact strength,” as described herein, refers to the kinetic energy needed to initiate fracture and continue the fracture until an article formed from the polymer blend described herein is broken as measured according to ASTM D256 at 23° C. and 2.75 J.

The term “peak energy,” as described herein, refers to the energy required to puncture a material by impact with a falling dart as measured with Instrumented Impact Testing according to ASTM D3763.

The term “sufficient impact strength,” as described herein, refers to a Notched Izod Impact strength greater than or equal to 200 J/m and a peak energy greater than or equal to 30 J.

The term “ductile break,” as described herein, refers to extensive plastic deformation ahead of crack and the crack is stable in that it resists further extension unless applied stress is increased as exhibited after being subjected to Instrumented Impact Testing according to ASTM D3763. The term “brittle break,” as described herein, refers to relatively little plastic deformation and the crack is unstable in that it propagates rapidly without increase in applied stress as exhibited after being subjected to Instrumented Impact Testing according to ASTM D3763. A ductile break is preferred to a brittle break.

The term “specific gravity,” as described herein, refers to the ratio of the density of a material to the density of water and is measured according to ASTM D792 at 23° C.

The term “density,” as described herein, refers to the mass per unit volume of a substance as measured according to ASTM D792 at 23° C.

The term “decomposition temperature,” as described herein, refers to the temperature at which a substance chemically decomposes as measured by thermogravimetric analysis.

The term “particle size distribution D50,” as described herein, means that 50% of the particles have diameters below the given size.

The term “particle size distribution D95,” as described herein, means that 95% of the particles have diameters below the given size.

The term “Shore D Hardness,” as described herein, refers to the hardness of a material as measured in accordance with ASTM D2240.

The term “flammability rating,” as described herein, refers to the comparative burning characteristics of a solid-plastic material at the given thickness measured in accordance with UL 94 Standard Test Procedures.

For UL 94 V-0, V-1, and V-2 classifications, 10 specimens having a size of 125 mm×13 mm are tested per thickness. The specimens are tested after conditioning 48 hours at 23° C. and 50% relative humidity. The specimen is mounted with long axis vertical. The specimen is supported such that its lower end is 10 mm above a Bunsen burner tube. A blue 20 mm high flame is applied to the center of the lower edge of specimen for 10 seconds. If burning ceases within 30 seconds, the flame is re-applied for an additional 10 seconds. If the specimen drips particles, these shall be allowed to fall onto a layer of untreated surgical cotton placed 300 mm below the specimen. A rating of “V-0” requires: (A) not have any specimen that burns with flaming combustion for more than 10 seconds after either application of the test flame; (B) not have a total flaming combustion time exceeding 50 seconds for the 10 flame applications; (C) not have any specimens that burn with flaming or glowing combustion up to the holding clamp; (D) not have any specimens that drip flaming particles that ignite the dry absorbent surgical cotton located 300 mm below the test specimen; and (E) not have any specimens with glowing combustion that persists for more than 30 seconds after the second removal of the test flame. A rating of “V-1” requires: (A) not have any specimen that burns with flaming combustion for more than 30 seconds after either application of the test flame; (B) not have a total flaming combustion time exceeding 250 seconds for the 10 flame applications; (C) not have any specimens that burn with flaming or glowing combustion up to the holding clamp; (D) not have any specimens that drip flaming particles that ignite the dry absorbent surgical cotton located 300 mm below the test specimen; and (E) not have any specimens with glowing combustion that persists for more than 60 seconds after the second removal of the test flame. A rating of “V-2” requires: (A) not have any specimen that burns with flaming combustion for more than 30 seconds after either application of the test flame; (B) not have a total flaming combustion time exceeding 250 seconds for the 10 flame applications; (C) not have any specimens that burn with flaming or glowing combustion up to the holding clamp; (D) be permitted to have specimens that drip flaming particles that burn only briefly, some of which ignite the dry absorbent surgical cotton located 300 mm below the test specimen; and (E) not have any specimens with glowing combustion that persists for more than 60 seconds after the second removal of the test flame.

For UL 94 5VA and 5VB classifications, 5 specimens (i.e., bars) having a size of 125 mm×13 mm and 3 specimens (i.e., plaques) having a size of 150 mm×150 mm are tested per thickness. The specimens are tested after conditioning 48 hours at 23° C. and 50% relative humidity. The specimen is mounted with its long axis vertical. A 125 mm overall high Bunsen burner flame with a 40 mm blue inner cone is applied to the center of the bottom surface of the specimen at an angle of 20° from the vertical such that the tip of the blue cone touches the specimen. The flame is applied for 5 seconds and removed for 5 seconds. The operation is repeated until the specimen has been subjected to 5 applications of the test flame. A rating of “5VA” requires: (A) bar specimens have UL-94 V-0 or V-1 classification; (B) not have any specimen that burns with flaming combustion for more than 60 seconds after the fifth flame; (C) not have any specimens that drip flaming particles that ignite the dry absorbent surgical cotton located 300 mm below the specimen; and (D) not have any specimen that exhibits a burn through (hole). A rating of “5VB” requires: (A) bar specimens have UL-94 V-9 or V-1 classification; (B) not have any specimen that burns with flaming combustion for more than 60 seconds after the fifth flame; (C) not have any specimens that drip flaming particles that ignite the dry absorbent surgical cotton located 300 mm below the specimen; and (D) have a specimen that exhibits a burn through (hole).

The term “acid value,” as described herein, refers to the mass of potassium hydroxide (KOH) in milligrams (mg) that is required to neutralize one gram of a chemical substance as measured in accordance ASTM D3644.

The term “glass transition temperature,” as described herein, refers to the temperature region where the polymer transitions from a hard, glassy material to a soft, rubbery material as measured by dynamic mechanical analysis in accordance with ASTM D4440.

The amount (wt %) of P₂O₅ and CaO in the hydroxyapatite stabilizer is determined by X-ray fluorescence (XRF).

The term “loss on ignition,” as described herein, refers to the mass loss of a combustion residue whenever it is heated in an air/oxygen atmosphere to 800° C. as measured in accordance with ASTM D7348.

As stated above, conventional ABS and PC blends provide the heat resistance and tensile stiffness (i.e., heat deflection temperature of about 90° C. and tensile modulus of about 2700 MPa) necessary for a broad range of applications, including healthcare, automotive, and electronic applications. PC is a stiff, amorphous thermoplastic that imparts heat resistance to the polymer blend. ABS is also an amorphous thermoplastic, but has a lower tensile and flexural stiffness than PC. Accordingly, ABS reduces the tensile and flexural stiffness, thereby improving flexibility, and improves the processability of conventional ABS and PC blends. However, conventional ABS and PC blends have relatively low chemical resistance, particularly towards organic solvents, hydrocarbons, and select alcohols, and may not be sufficient for certain applications in the healthcare, automotive, and electronic fields. Moreover, materials used for said applications may require a high level of flame resistance in addition to chemical resistance.

Disclosed herein are polymer blends which mitigate the aforementioned problems. Specifically, the polymer blends disclosed herein comprise a blend of aliphatic polyketone, ABS, and flame retardant, which results in a chemically resistant and flame retardant polymer blend having improved heat resistance and sufficient tensile and flexural strength and stiffness. Aliphatic polyketone is a semicrystalline thermoplastic that, similar to PC, increases the heat resistance of the polymer blend. Contrary to its function in conventional ABS and PC blends, ABS imparts tensile and flexural stiffness to the aliphatic polyketone and ABS blend. While not wishing to be bound by theory, it is believed that the resistance of the aliphatic polyketone to non-aqueous solutions and the resistance of the ABS to aqueous solutions results in the overall improved chemical resistance of the aliphatic polyketone and ABS polymer blend. Additionally, it is believed that the semicrystalline structure of aliphatic polyketone results in improved chemical resistance as compared to the amorphous structure of PC. Furthermore, with the addition of a flame retardant, the chemically resistant aliphatic polyketone and ABS polymer blends exhibit flame retardancy. Moreover, a rubber-containing impact modifier may be added to provide sufficient impact strength.

The polymer blends disclosed herein may generally be described as comprising an aliphatic polyketone, an acrylonitrile butadiene styrene (ABS), and a flame retardant.

Aliphatic Polyketone

As described hereinabove, aliphatic polyketone increases the heat resistance of the polymer blend. The combination of aliphatic polyketone and ABS results in a polymer blend with improved chemical resistance as compared to conventional ABS and PC blends. While not wishing to be bound by theory, it is believed that this improved chemical resistance results from the resistance of the aliphatic polyketone to non-aqueous solutions and the resistance of the ABS to aqueous solutions. Additionally, it is believed that the semicrystalline structure of aliphatic polyketone results in improved chemical resistance as compared to the amorphous structure of PC.

Accordingly, in embodiments, aliphatic polyketone is included in amounts greater than or equal to 45 wt % such that the aliphatic polyketone may increase the heat resistance and elongation at yield and contribute to the overall chemical resistance of the polymer blend. In embodiments, the amount of aliphatic polyketone may be limited (e.g., less than or equal to 90 wt %) and balanced with the ABS such that the tensile and flexural stiffness of the polymer blend are not reduced below a desired amount (e.g., greater than or equal to 1600 MPa and greater than or equal to 1900 MPa, respectively) due to the presence of the aliphatic polyketone. In embodiments, the amount of aliphatic polyketone in the polymer blend may be greater than or equal to 45%, greater than or equal to 50%, greater than or equal to 55 wt %, greater than or equal to 60 wt %, greater than or equal to 65 wt %, or even greater than or equal to 68 wt %. In embodiments, the amount of aliphatic polyketone may be less than or equal to 90 wt %, less than or equal to 85 wt %, less than or equal to 80 wt %, less than or equal to 75 wt %, or even less than or equal to 70 wt %. In embodiments, the amount of aliphatic polyketone in the polymer blend may be greater than or equal to 45 wt % and less than or equal to 90 wt %, greater than or equal to 45 wt % and less than or equal to 85 wt %, greater than or equal to 45 wt % and less than or equal to 80 wt %, greater than or equal to 45 wt % and less than or equal to 75 wt %, greater than or equal to 45 wt % and less than or equal to 70 wt %, greater than or equal to 50 wt % and less than or equal to 90 wt %, greater than or equal to 50 wt % and less than or equal to 85 wt %, greater than or equal to 50 wt % and less than or equal to 80 wt %, greater than or equal to 50 wt % and less than or equal to 75 wt %, greater than or equal to 50 wt % and less than or equal to 70 wt %, greater than or equal to 55 wt % and less than or equal to 90 wt %, greater than or equal to 55 wt % and less than or equal to 85 wt %, greater than or equal to 55 wt % and less than or equal to 80 wt %, greater than or equal to 55 wt % and less than or equal to 75 wt %, greater than or equal to 55 wt % and less than or equal to 70 wt %, greater than or equal to 60 wt % and less than or equal to 90 wt %, greater than or equal to 60 wt % and less than or equal to 85 wt %, greater than or equal to 60 wt % and less than or equal to 80 wt %, greater than or equal to 60 wt % and less than or equal to 75 wt %, greater than or equal to 60 wt % and less than or equal to 70 wt %, greater than or equal to 65 wt % and less than or equal to 90 wt %, greater than or equal to 65 wt % and less than or equal to 85 wt %, greater than or equal to 65 wt % and less than or equal to 80 wt %, greater than or equal to 65 wt % and less than or equal to 75 wt %, greater than or equal to 65 wt % and less than or equal to 70 wt %, greater than or equal to 68 wt % and less than or equal to 90 wt %, greater than or equal to 68 wt % and less than or equal to 85 wt %, greater than or equal to 68 wt % and less than or equal to 80 wt %, greater than or equal to 68 wt % and less than or equal to 75 wt %, or even greater than or equal to 68 wt % and less than or equal to 70 wt %, or any and all sub-ranges formed from any of these endpoints.

In embodiments, the aliphatic polyketone may have a melt flow rate greater than or equal to 1 g/10 min, greater than or equal to 10 g/10 min, greater than or equal to 20 g/10 min, greater than or equal to 30 g/10 min, or even greater than or equal to 40 g/10 min as measured in accordance with ASTM D1238 at 240° C. and a weight of 2.16 kg. While not wishing to be bound by theory, although an aliphatic polyketone with a higher melt flow rate (e.g., greater than 90 g/10 min) improves the flow of the polymer blend, a higher melt flow rate aliphatic polyketone may not adequately disperse the ABS, which may negatively affect the chemical resistance and impact strength of the polymer blend. Accordingly, in embodiments, the aliphatic polyketone may have a melt flow rate less than or equal to 90 g/10 min, less than or equal to 80 g/10 min, less than or equal to 60 g/10 min, less than or equal to 40 g/10 min, or even less than or equal to 20 g/10 min as measured in accordance with ASTM D1238 at 240° C. and a weight of 2.16 kg. In embodiments, the aliphatic polyketone may have a melt flow rate greater than or equal to 1 g/10 min and less than or equal to 90 g/10 min, greater than or equal to 1 g/10 min and less than or equal to 80 g/10 min, greater than or equal to 1 g/10 min and less than or equal to 60 g/10 min, greater than or equal to 1 g/10 min and less than or equal to 40 g/10 min, greater than or equal to 1 g/10 min and less than or equal to 20 g/10 min, greater than or equal to 10 g/10 min and less than or equal to 90 g/10 min, greater than or equal to 10 g/10 min and less than or equal to 80 g/10 min, greater than or equal to 10 g/10 min and less than or equal to 60 g/10 min, greater than or equal to 10 g/10 min and less than or equal to 40 g/10 min, greater than or equal to 10 g/10 min and less than or equal to 20 g/10 min, greater than or equal to 20 g/10 min and less than or equal to 90 g/10 min, greater than or equal to 20 g/10 min and less than or equal to 80 g/10 min, greater than or equal to 20 g/10 min and less than or equal to 60 g/10 min, greater than or equal to 20 g/10 min and less than or equal to 40 g/10 min, greater than or equal to 30 g/10 min and less than or equal to 90 g/10 min, greater than or equal to 30 g/10 min and less than or equal to 80 g/10 min, greater than or equal to 30 g/10 min and less than or equal to 60 g/10 min, greater than or equal to 30 g/10 min and less than or equal to 40 g/10 min, greater than or equal to 40 g/10 min and less than or equal to 90 g/10 min, greater than or equal to 40 g/10 min and less than or equal to 80 g/10 min, or even greater than or equal to 40 g/10 min and less than or equal to 60 g/10 min, or any and all sub-ranges formed from any of these endpoints as measured in accordance with ASTM D1238 at 240° C. and a weight of 2.16 kg. In embodiments, the aliphatic polyketone may include at least 2 different aliphatic polyketones (e.g., one with a relatively high melt flow rate and one with a relatively low melt flow rate) to achieve an intermediate melt flow rate (e.g., greater than or equal to 60 g/10 min).

In embodiments, the aliphatic polyketone may have a heat deflection temperature greater than or equal to 180° C. or even greater than or equal to 190° C. In embodiments, the aliphatic polyketone may have a heat deflection temperature less than or equal to 225° C. or even less than or equal to 210° C. In embodiments, the aliphatic polyketone may have a heat deflection temperature greater than or equal to 180° C. and less than or equal to 225° C., greater than or equal to 180° C. and less than or equal to 210° C., greater than or equal to 190° C. and less than or equal to 225° C., or even greater than or equal to 190° C. and less than or equal to 210° C., or any and all sub-ranges formed from any of these endpoints.

In embodiments, the aliphatic polyketone may have a tensile modulus greater than or equal to 1300 MPa or even greater than or equal to 1400 MPa. In embodiments, the aliphatic polyketone may have a tensile modulus less than or equal to 1800 MPa or even less than or equal to 1700 MPa. In embodiments, the aliphatic polyketone may have a tensile modulus greater than or equal to 1300 MPa and less than or equal to 1800 MPa, greater than or equal to 1300 MPa and less than or equal to 1700 MPa, greater than or equal to 1400 MPa and less than or equal to 1800 MPa, or even greater than or equal to 1400 MPa and less than or equal to 1700 MPa, or any and all sub-ranges formed from any of these endpoints.

In embodiments, the aliphatic polyketone may have a tensile strength at yield greater than or equal to 45 MPa or even greater than or equal to 55 MPa. In embodiments, the aliphatic polyketone may have a tensile strength at yield less than or equal to 75 MPa or even less than or equal to 65 MPa. In embodiments, the aliphatic polyketone may have a tensile strength at yield greater than or equal to 45 MPa and less than or equal to 75 MPa, greater than or equal to 45 MPa and less than or equal to 65 MPa, greater than or equal to 55 MPa and less than or equal to 75 MPa, or even greater than or equal to 55 MPa and less than or equal to 65 MPa, or any and all sub-ranges formed from any of these endpoints.

In embodiments, the aliphatic polyketone may have a tensile elongation at yield greater than or equal to 15% or even greater than or equal to 20%. In embodiments, the aliphatic polyketone may have a tensile elongation at yield less than or equal to 30% or even less than or equal to 25%. In embodiments, the aliphatic polyketone may have a tensile elongation at yield greater than or equal to 15% and less than or equal to 30%, greater than or equal to 15% and less than or equal to 25%, greater than or equal to 20% and less than or equal to 30%, or even greater than or equal to 20% and less than or equal to 25%, or any and all sub-ranges formed from any of these endpoints.

In embodiments, the aliphatic polyketone may have a flexural modulus greater than or equal to 1200 MPa or even greater than or equal to 1300 MPa. In embodiments, the aliphatic polyketone may have a flexural modulus less than or equal to 1700 MPa or even less than or equal to 1600 MPa. In embodiments, the aliphatic polyketone may have a flexural modulus greater than or equal to 1200 MPa and less than or equal to 1700 MPa, greater than or equal to 1200 MPa and less than or equal to 1600 MPa, greater than or equal to 1300 MPa and less than or equal to 1700 MPa, or even greater than or equal to 1300 MPa and less than or equal to 1600 MPa, or any and all sub-ranges formed from any of these endpoints.

In embodiments, the aliphatic polyketone may have a flexural strength greater than or equal to 40 MPa or even greater than or equal to 50 MPa. In embodiments, the aliphatic polyketone may have a flexural strength less than or equal to 70 MPa or even less than or equal to 60 MPa. In embodiments, the aliphatic polyketone may have a flexural strength greater than or equal to 40 MPa and less than or equal to 70 MPa, greater than or equal to 40 MPa and less than or equal to 60 MPa, greater than or equal to 50 MPa and less than or equal to 70 MPa, or even greater than or equal to 50 MPa and less than or equal to 60 MPa, or any and all sub-ranges formed from any of these endpoints.

In embodiments, the aliphatic polyketone may have a Notched Izod Impact strength greater than or equal to 75 J/m, greater than or equal to 100 J/m, greater than or equal to 150 J/m, or even greater than or equal to 200 J/m. In embodiments, the aliphatic polyketone may have a Notched Izod Impact strength less than or equal to 250 J/m or even less than or equal to 225 J/m. In embodiments, the aliphatic polyketone may have a Notched Izod Impact strength greater than or equal to 75 J/m and less than or equal to 250 J/m, greater than or equal to 75 J/m and less than or equal to 225 J/m, greater than or equal to 100 J/m and less than or equal to 250 J/m, greater than or equal to 100 J/m and less than or equal to 225 J/m, greater than or equal to 150 J/m and less than or equal to 250 J/m, greater than or equal to 150 J/m and less than or equal to 225 J/m, greater than or equal to 200 J/m and less than or equal to 250 J/m, or even greater than or equal to 200 J/m and less than or equal to 225 J/m, or any and all sub-ranges formed from any of these endpoints.

In embodiments, the aliphatic polyketone may have a specific gravity greater than or equal to 1.15 or even greater than or equal to 1.2. In embodiments, the aliphatic polyketone may have a specific gravity less than or equal to 1.3 or even less than or equal to 1.25. In embodiments, the aliphatic polyketone may have a specific gravity greater than or equal to 1.15 and less than or equal to 1.3, greater than or equal to 1.15 and less than or equal to 1.25, greater than or equal to 1.2 and less than or equal to 1.3, or even greater than or equal to 1.2 and less than or equal to 1.25, or any and all sub-ranges formed from any of these endpoints.

Suitable commercial embodiments of the aliphatic polyketone are available under the POKETONE brand from Hyosung, such as grades M330, M630, and M930 containing various additives as denoted by “A,” “F,” “S,” or others, or containing no additives as designated by “P.” The polymer blends described herein may include a powdered grade of aliphatic polyketone, such as POKETONE M630P, in addition to another grade of aliphatic polyketone, such as POKETONE M630A, to ensure easier dosing of the additional components of the blends. Table 1 shows certain properties of POKETONE M330A, M630A, and M930A.

TABLE 1

| | POKETONE | POKETONE | POKETONE |
|---|---|---|---|
| | M330A | M630A | M930A |
| Melt flow rate (g/10 min) | 60 | 6 | 200 |
| (240° C./2.16 kg) | | | |
| Heat deflection temp (° C.) | 200 | 195 | 105 |
| Tensile modulus (MPa) | 1600 | 1450 | |
| Tensile strength at | 60 | 58 | 62 |
| yield (MPa) | | | |
| Tensile elongation at | 21 | 22 | — |
| yield (%) | | | |
| Tensile elongation at | 300 | 300 | 130 |
| break (%) | | | |
| Flexural modulus (MPa) | 1500 | 1350 | 1600 |
| Flexural strength (MPa) | 57 | 53 | 60 |
| Notched Izod impact | 95 | 220 | — |
| strength (J/m) | | | |
| Specific gravity | 1.24 | 1.24 | 1.24 |

Acrylonitrile Butadiene Styrene (ABS)

As stated above, ABS increases the tensile and flexural stiffness of the polymer blend, and the combination of ABS and aliphatic polyketone results in a polymer blend with improved chemical resistance as compared to conventional ABS and PC blends. While not wishing to be bound by theory, it is believed that this improved chemical resistance results from the resistance of the aliphatic polyketone to non-aqueous solutions and the resistance of the ABS to aqueous solutions.

Accordingly, in embodiments, ABS is included in amounts greater than or equal to 7.5 wt % such that the ABS may increase the tensile and flexural stiffness and contribute to the overall chemical resistance of the polymer blend. In embodiments, the amount of ABS may be limited (e.g., less than or equal to 40 wt %) such that the heat resistance is not reduced below a desired amount (e.g., heat deflection temperature greater than or equal to 100° C.) due to the presence of ABS. In embodiments, the amount of ABS in the polymer blend may be greater than or equal to 7.5 wt %, greater than or equal to 10 wt %, greater than or equal to 14 wt %, greater than or equal to 18 wt %, greater than or equal to 20 wt %, greater than or equal to 24 wt %, or even greater than or equal to 28 wt %. In embodiments, the amount of ABS in the polymer blend may be less than or equal to 40 wt %, less than or equal to 35 wt %, or even less than or equal to 30 wt %. In embodiments, the amount of ABS in the polymer blend may be greater than or equal to 7.5 wt % and less than or equal to 40 wt %, greater than or equal to 7.5 wt % and less than or equal to 35 wt %, greater than or equal to 7.5 wt % and less than or equal to 30 wt %, greater than or equal to 10 wt % and less than or equal to 40 wt %, greater than or equal to 10 wt % and less than or equal to 35 wt %, greater than or equal to 10 wt % and less than or equal to 30 wt %, greater than or equal to 14 wt % and less than or equal to 40 wt %, greater than or equal to 14 wt % and less than or equal to 35 wt %, greater than or equal to 14 wt % and less than or equal to 30 wt %, greater than or equal to 18 wt % and less than or equal to 40 wt %, greater than or equal to 18 wt % and less than or equal to 35 wt %, greater than or equal to 18 wt % and less than or equal to 30 wt %, greater than or equal to 20 wt % and less than or equal to 40 wt %, greater than or equal to 20 wt % and less than or equal to 35 wt %, greater than or equal to 20 wt % and less than or equal to 30 wt %, greater than or equal to 24 wt % and less than or equal to 40 wt %, greater than or equal to 24 wt % and less than or equal to 35 wt %, greater than or equal to 24 wt % and less than or equal to 30 wt %, greater than or equal to 28 wt % and less than or equal to 40 wt %, greater than or equal to 28 wt % and less than or equal to 35 wt %, or even greater than or equal to 28 wt % and less than or equal to 30 wt %, or any and all sub-ranges formed from any of these endpoints.

In embodiments, the ABS may comprise an emulsion ABS produced via an emulsion polymerization process. In embodiments, the ABS may comprise bulk ABS, a purer ABS produced with minimal additives by mass polymerization.

In embodiments, the ABS may have a melt flow rate greater than or equal to 1 g/10 min, greater than or equal to 3 g/10 min, or even greater than or equal to 5 g/10 min as measured in accordance with ASTM D1238 at 230° C. and a weight of 3.8 kg. In embodiments, the ABS may have a melt flow rate less than or equal to 20 g/10 min or even less than or equal to 10 g/10 min as measured in accordance with ASTM D1238 at 230° C. and a weight of 3.8 kg. In embodiments, the ABS may have a melt flow rate greater than or equal to 1 g/10 min and less than or equal to 20 g/10 min, greater than or equal to 1 g/10 min and less than or equal to 10 g/10 min, greater than or equal to 3 g/10 min and less than or equal to 20 g/10 min, greater than or equal to 3 g/10 min and less than or equal to 10 g/10 min, greater than or equal to 5 g/10 min and less than or equal to 20 g/10 min, or even greater than or equal to 5 g/10 min and less than or equal to 10 g/10 min, or any and all sub-ranges formed from any of these endpoints as measured in accordance with ASTM D1238 at 230° C. and a weight of 3.8 kg.

In embodiments, the ABS may have a tensile modulus greater than or equal to 2000 MPa or even greater than or equal to 2500 MPa. In embodiments, the ABS may have a tensile modulus less than or equal to 3500 MPa or even less than or equal to 3000 MPa. In embodiments, the ABS may have a tensile modulus greater than or equal to 2000 MPa and less than or equal to 3500 MPa, greater than or equal to 2000 MPa and less than or equal to 3000 MPa, greater than or equal to 2500 MPa and less than or equal to 3500 MPa, or even greater than or equal to 2500 MPa and less than or equal to 3000 MPa, or any and all sub-ranges formed from any of these endpoints.

In embodiments, the ABS may have a tensile strength at yield greater than or equal to 30 MPa, greater than or equal to 35 MPa, or even greater than or equal to 40 MPa. In embodiments, the ABS may have a tensile strength at yield less than or equal to 50 MPa or even less than or equal to 45 MPa. In embodiments, the ABS may have a tensile strength at yield greater than or equal to 30 MPa and less than or equal to 50 MPa, greater than or equal to 30 MPa and less than or equal to 45 MPa, greater than or equal to 35 MPa and less than or equal to 50 MPa, greater than or equal to 35 MPa and less than or equal to 45 MPa, greater than or equal to 40 MPa and less than or equal to 50 MPa, or even greater than or equal to 40 MPa and less than or equal to 45 MPa, or any and all sub-ranges formed from any of these endpoints.

In embodiments, the ABS may have a tensile elongation at yield greater than or equal to 1% or even greater than or equal to 1.5%. In embodiments, the ABS may have a tensile elongation at yield less than or equal to 5% or even less than or equal to 4%. In embodiments, the ABS may have a tensile elongation at yield greater than or equal to 1% and less than or equal to 5%, greater than or equal to 1% and less than or equal to 4%, greater than or equal to 1.5% and less than or equal to 5%, or even greater than or equal to 1.5% and less than or equal to 4%, or any and all sub-ranges formed from any of these endpoints.

In embodiments, the ABS may have a tensile elongation at break greater than or equal to 5% or even greater than or equal to 10%. In embodiments, the ABS may have a tensile elongation at break less than or equal to 40% or even less than or equal to 35%. In embodiments, the ABS may have a tensile elongation at break greater than or equal to 5% and less than or equal to 40%, greater than or equal to 5% and less than or equal to 35%, greater than or equal to 10% and less than or equal to 40%, or even greater than or equal to 10% and less than or equal to 35%, or any and all sub-ranges from any of these endpoints.

In embodiments, the ABS may have a flexural modulus greater than or equal to 2400 MPa or even greater than or equal to 2500 MPa. In embodiments, the ABS may have a flexural modulus less than or equal to 2800 MPa or even less than or equal to 2700 MPa. In embodiments, the ABS may have a flexural modulus greater than or equal to 2400 MPa and less than or equal to 2800 MPa, greater than or equal to 2400 MPa and less than or equal to 2700 MPa, greater than or equal to 2500 MPa and less than or equal to 2800 MPa, or even greater than or equal to 2500 MPa and less than or equal to 2700 MPa, or any and all sub-ranges formed from any of these endpoints.

In embodiments, the ABS may have a flexural strength greater than or equal to 60 MPa or even greater than or equal to 70 MPa. In embodiments, the ABS may have a flexural strength less than or equal to 90 MPa or even less than or equal to 80 MPa. In embodiments, the ABS may have a flexural strength greater than or equal to 60 MPa and less than or equal to 90 MPa, greater than or equal to 60 MPa and less than or equal to 80 MPa, greater than or equal to 70 MPa and less than or equal to 90 MPa, or even greater than or equal to 70 MPa and less than or equal to 80 MPa, or any and all sub-ranges formed from any of these endpoints.

In embodiments, the ABS may have a Notched Izod Impact strength greater than or equal to 200 J/m, greater than or equal to 300 J/m, or even greater than or equal to 350 J/m. In embodiments, the ABS may have a Notched Izod Impact strength less than or equal to 500 J/m or even less than or equal to 400 J/m. In embodiments, the ABS may have a Notched Izod Impact strength greater than or equal to 250 J/m and less than or equal to 500 J/m, greater than or equal to 250 J/m and less than or equal to 400 J/m, greater than or equal to 300 J/m and less than or equal to 500 J/m, greater than or equal to 300 J/m and less than or equal to 400 J/m, greater than or equal to 350 J/m and less than or equal to 500 J/m, or even greater than or equal to 350 J/m and less than or equal to 400 J/m, or any and all sub-ranges formed from any of these endpoints.

Suitable commercial embodiments of the ABS are available under the LUSTRAN brand from INEOS Styrolution, such as grades 348 and 433, and under the MAGNUM brand from Trinseo, such as grade 8391 MED Table 2 shows certain properties of LUSTRAN 348 and 433 and MAGNUM 8391 MED.

TABLE 2

| | LUSTRAN | LUSTRAN | MAGNUM |
|---|---|---|---|
| | 348 | 433 | 8391 MED |
| Melt flow rate (g/10 min) | 5 | 3.6 | 8 |
| (230° C./3.8 kg) | | | |
| Tensile modulus (MPa) | 2600 | 2551 | 2340 |
| Tensile strength at | 48 | 42 | 48 |
| yield (MPa) | | | |
| Tensile elongation at | 25 | 30 | 8.7 |
| break (%) | | | |
| Flexural modulus (MPa) | 2700 | 2620 | 2480 |
| Flexural strength (MPa) | 76 | 72 | 75 |
| Notched Izod Impact | 214 | 374 | 230 |
| strength (J/m) | | | |

Flame Retardant

In addition to improved chemical resistance, the polymer blends described herein exhibit flame retardancy. For example, flame retardant aliphatic polyketone and ABS blends may be desirable in healthcare (e.g., medical device housing and enclosures), automotive, electronic, and food production (e.g., belt system) applications. Accordingly, a flame retardant is included in the polymer blends described herein to increase the flame retardancy of the polymer blends.

In embodiments, the amount of flame retardant in the polymer blend may be greater than 0 wt %, greater than or equal to 2.5 wt %, greater than or equal to 5 wt %, or even greater than or equal to 10 wt %. In embodiments, the amount of flame retardant in the in the polymer blend may be less than or equal to 25 wt %, less than or equal to 20 wt %, less than or equal to 17.5 wt %, less than or equal to 15 wt %, or even less than or equal to 12.5 wt %. In embodiments, the amount of flame retardant in the polymer blend may be greater than 0 wt % and less than or equal to 25 wt %, greater than 0 wt % and less than or equal to 20 wt %, greater than 0 wt % and less than or equal to 17.5 wt %, greater than 0 wt % and less than or equal to 15 wt %, greater than 0 wt % and less than or equal to 12.5 wt %, greater than or equal to 2.5 wt % and less than or equal to 25 wt %, greater than or equal to 2.5 wt % and less than or equal to 20 wt %, greater than or equal to 2.5 wt % and less than or equal to 17.5 wt %, greater than or equal to 2.5 wt % and less than or equal to 15 wt %, greater than or equal to 2.5 wt % and less than or equal to 12.5 wt %, greater than or equal to 5 wt % and less than or equal to 17.5 wt %, greater than or equal to 5 wt % and less than or equal to 15 wt %, greater than or equal to 5 wt % and less than or equal to 12.5 wt %, greater than or equal to 10 wt % and less than or equal to 17.5 wt %, greater than or equal to 10 wt % and less than or equal to 15 wt %, or even greater than or equal to 10 wt % and less than or equal to 12.5 wt %, or any and all sub-ranges formed from any of these endpoints.

In embodiments, the flame retardant may comprise inorganic phosphorous containing salts, phosphinates, organic phosphinates, phosphate compounds (e.g., organic phosphate esters, aryl phosphates, halogen-containing phosphates, and oligo-phosphates), polyphosphates (e.g., melamine polyphosphate), polyphosphonates (and corresponding co-polymers), halogenated aromatic, polymeric halogenated compounds, antimony trioxide, or a combination thereof.

In embodiments, the flame retardant may have a density greater than or equal to 1.2 g/cm³ or even greater than or equal to 1.3 g/cm³. In embodiments, the flame retardant may have a density less than or equal to 2.3 g/cm³, less than or equal to 2.0 g/cm³, or even less than or equal to 1.7 g/cm³. In embodiments, the flame retardant may have a density greater than or equal to 1.2 g/cm³ and less than or equal to 2.3 g/cm³, greater than or equal to 1.2 g/cm³ and less than or equal to 2.0 g/cm³, greater than or equal to 1.2 g/cm³ and less than or equal to 1.7 g/cm³, greater than or equal to 1.3 g/cm³ and less than or equal to 2.3 g/cm³, greater than or equal to 1.3 g/cm³ and less than or equal to 2.0 g/cm³, or even greater than or equal to 1.3 g/cm³ and less than or equal to 1.7 g/cm³, or any and all sub-ranges formed from any of these endpoints.

In embodiments, the flame retardant may have a decomposition temperature greater than or equal to 250° C., greater than or equal to 275° C., or even greater than or equal to 300° C.

In embodiments, the flame retardant may have a particle size distribution D50 greater than or equal to 1 μm, greater than or equal to 10 μm, or even greater than or equal to 20 μm. In embodiments, the flame retardant may have a particle size distribution D50 less than or equal to 60 μm or even less than or equal to 50 μm. In embodiments, the flame retardant may have a particle size distribution D50 greater than or equal to 1 μm and less than or equal to 60 μm, greater than or equal to 1 μm and less than or equal to 50 μm, greater than or equal to 10 μm and less than or equal to 60 μm, greater than or equal to 10 μm and less than or equal to 50 μm, greater than or equal to 20 μm and less than or equal to 60 μm, or even greater than or equal to 20 μm and less than or equal to 50 μm, or any and all sub-ranges formed from any of these endpoints.

Suitable commercial embodiments of the flame retardant are available under the EXOLIT brand from Clariant, such as grades OP 935 and OP 1230; under the FYROLFLEX brand from ICL Industrial Products, such as grade SOL-DP; under the JLS brand from HangZhou, such as grade PNA-350; and under the BC brand from Lanxess, such as grade 58. Table 3 shows certain properties of EXOLIT OP 935, EXOLIT OP1230, FYROFLEX SOL-DP, JLS PNA-350, and BC-58.

TABLE 3

| | EXOLIT | EXOLIT | FYROFLEX | JLS | |
|---|---|---|---|---|---|
| | OP 935 | OP 1230 | SOL-DP | PNA-350 | BC-58 |
| Density (g/cm³) | 1.35 | 1.35 | 1.347 | 1.7 | 2.2 |
| Decomposition | >300 | >300 | 326 | >350 | 380 |
| temperature (° C.) | | | | | |
| Melting range (° C.) | — | — | 102-104 | — | 200-230 |
| Particle size | ≤10 (D95) | 20-40 (D50) | 47.0 (D50) | | — |
| distribution (μm) | | | | | |

Polymer Blend

As described hereinabove, aliphatic polyketone increases the heat resistance of the polymer blend, but may decrease the tensile and flexural stiffness of the polymer blend. While ABS increases the tensile and flexural stiffness of the polymer blend, ABS may decrease the heat resistance of the polymer blend. Accordingly, in achieving a polymer blend having an improved chemical resistance, the amount of aliphatic polyketone should be balanced with the amount of ABS to maintain improved heat resistance and achieve the desired tensile and flexural stiffness. In embodiments, the ratio by weight of aliphatic polyketone to ABS may be from 2:1 to 6:1, from 2:1 to 5:1, from 2:1 to 4:1, from 2:1 to 3:1, from 2:1 to 2.5:1, from 2:1 to 2.3:1, from 2.3:1 to 6:1, from 2.3:1 to 5:1, from 2.3:1 to 4:1, from 2.3:1 to 3:1, from 2.3:1 to 2.5:1, from 2.5:1 to 6:1, from 2.5:1 to 5:1, from 2.5:1 to 4:1, from 2.5:1 to 3:1, from 3:1 to 6:1, from 3:1 to 5:1, from 3:1 to 4:1, from 4:1 to 6:1, from 4:1 to 5:1, or even from 5:1 to 6:1, or any and all sub-ranges formed from any of these endpoints.

Aliphatic polyketones increase the heat resistance of the polymer blend as evidenced by the heat deflection temperature of the polymer blend. A higher heat deflection temperature indicates an increase in the polymer blend's ability to resist distortion under a given load at an elevated temperature. Certain applications may require heat deflection temperatures (e.g., greater than or equal to 100° C.). In embodiments, the polymer blend may have a heat deflection temperature greater than or equal to 100° C. or even greater than or equal to 110° C. In embodiments, the polymer blend may have a heat deflection temperature less than or equal to 175° C., less than or equal to 150° C., or even less than or equal to 125° C. In embodiments, the polymer blend may have a heat deflection temperature greater than or equal to 100° C. and less than or equal to 175° C., greater than or equal to 100° C. and less than or equal to 150° C., greater than or equal to 100° C. and less than or equal to 125° C., greater than or equal to 110° C. and less than or equal to 175° C., greater than or equal to 110° C. and less than or equal to 150° C., or even greater than or equal to 110° C. and less than or equal to 125° C., or any and all sub-ranges formed from any of these endpoints.

ABS increases the tensile and flexural stiffness of the polymer blend as evidenced by the tensile modulus of the polymer blend. A higher tensile and flexural modulus indicates an increased stiffness and, thus, correlates to a stronger polymer blend. In embodiments, the polymer blend may have a tensile modulus greater than or equal to 1600 MPa or even greater than or equal to 1700 MPa. In embodiments, the polymer blend may have a tensile modulus less than or equal to 2500 MPa, less than or equal 2250 MPa, or even less than or equal to 2000 MPa. In embodiments, the polymer blend may have a tensile modulus greater than or equal to 1600 MPa and less than or equal to 2500 MPa, greater than or equal to 1600 MPa and less than or equal to 2250 MPa, greater than or equal to 1600 MPa and less than or equal to 2000 MPa, greater than or equal to 1700 MPa and less than or equal to 2500 MPa, greater than or equal to 1700 MPa and less than or equal to 2250 MPa, or even greater than or equal to 1700 MPa and less than or equal to 2000 MPa, or any and all sub-ranges formed from any of these endpoints. In embodiments, the polymer blend may have a flexural modulus greater than or equal to 1900 MPa or even greater than or equal to 2000 MPa. In embodiments, the polymer blend may have a flexural modulus less than or equal to 2750 MPa or even less than or equal to 2500 MPa. In embodiments, the polymer blend may have a flexural modulus greater than or equal to 1900 MPa and less than or equal to 2750 MPa, greater than or equal to 1900 MPa and less than or equal to 2500 MPa, greater than or equal to 2000 MPa and less than or equal to 2750 MPa, or even greater than or equal to 2000 MPa and less than or equal to 2500 MPa, or any and all sub-ranges formed from any of these endpoints.

In embodiments, the polymer blend may have a tensile strength at yield greater than or equal to 35 MPa, greater than or equal to 40 MPa, or even greater than or equal to 42 MPa. In embodiments, the polymer blend may have a tensile strength at yield less than or equal to 65 MPa, less than or equal to 60 MPa, less than or equal to 55 MPa, less than or equal to 50 MPa, or even less than or equal to 48 MPa. In embodiments, the polymer blend may have a tensile strength at yield greater than or equal to 35 MPa and less than or equal to 65 MPa, greater than or equal to 35 MPa and less than or equal to 60 MPa, greater than or equal to 35 MPa and less than or equal to 55 MPa, greater than or equal to 35 MPa and less than or equal to 50 MPa, greater than or equal to 35 MPa and less than or equal to 48 MPa, greater than or equal to 40 MPa and less than or equal to 65 MPa, greater than or equal to 40 MPa and less than or equal to 60 MPa, greater than or equal to 40 MPa and less than or equal to 55 MPa, greater than or equal to 40 MPa and less than or equal to 50 MPa, greater than or equal to 40 MPa and less than or equal to 48 MPa, greater than or equal to 42 MPa and less than or equal to 65 MPa, greater than or equal to 42 MPa and less than or equal to 60 MPa, greater than or equal to 42 MPa and less than or equal to 55 MPa, greater than or equal to 42 MPa and less than or equal to 50 MPa, or even greater than or equal to 42 MPa and less than or equal to 48 MPa, or any and all sub-ranges formed from any of these endpoints.

In embodiments, the polymer blend may have a tensile elongation at yield greater than or equal to 8%, greater than or equal to 10%, or even greater than or equal to 12%. In embodiments, the polymer blend may have a tensile elongation at yield less than or equal to 30%, less than or equal to 25%, less than or equal to 20%, or even less than or equal to 18%. In embodiments, the polymer blend have a tensile elongation at yield greater than or equal to 8% and less than or equal to 30%, greater than or equal to 8% and less than or equal to 25%, greater than or equal to 8% and less than or equal to 20%, greater than or 8% and less than or equal to 18%, greater than or equal to 10% and less than or equal to 30%, greater than or equal to 10% and less than or equal to 25%, greater than or equal to 10% and less than or equal to 20%, greater than or equal to 10% and less than or equal to 18%, greater than or equal to 12% and less than or equal to 30%, greater than or equal to 12% and less than or equal to 25%, greater than or equal to 12% and less than or equal to 20%, or even greater than or equal to 12% and less than or equal to 18%, or any and all sub-ranges formed from any of these endpoints. In embodiments, the polymer blend may not exhibit a defined tensile elongation at yield.

In embodiments, the polymer blend may have a tensile strength at break greater than or equal to 35 MPa, greater than or equal to 40 MPa, or even greater than or equal to 42 MPa. In embodiments, the polymer blend may have a tensile strength at break less than or equal to 65 MPa, less than or equal to 60 MPa, less than or equal to 55 MPa, less than or equal to 50 MPa, or even less than or equal to 48 MPa. In embodiments, the polymer blend may have a tensile strength at break greater than or equal to 35 MPa and less than or equal to 65 MPa, greater than or equal to 35 MPa and less than or equal to 60 MPa, greater than or equal to 35 MPa and less than or equal to 55 MPa, greater than or equal to 35 MPa and less than or equal to 50 MPa, greater than or equal to 35 MPa and less than or equal to 48 MPa, greater than or equal to 40 MPa and less than or equal to 65 MPa, greater than or equal to 40 MPa and less than or equal to 60 MPa, greater than or equal to 40 MPa and less than or equal to 55 MPa, greater than or equal to 40 MPa and less than or equal to 50 MPa, greater than or equal to 40 MPa and less than or equal to 48 MPa, greater than or equal to 42 MPa and less than or equal to 65 MPa, greater than or equal to 42 MPa and less than or equal to 60 MPa, greater than or equal to 42 MPa and less than or equal to 55 MPa, greater than or equal to 42 MPa and less than or equal to 50 MPa, or even greater than or equal to 42 MPa and less than or equal to 48 MPa, or any and all sub-ranges formed from any of these endpoints.

In embodiments, the polymer blend may have a tensile elongation at break greater than or equal to 8%, greater than or equal to 15%, or even greater than or equal to 20%. In embodiments, the polymer blend may have a tensile elongation at break less than or equal to 200%, less than or equal to 150%, or even less than or equal to 100%. In embodiments, the polymer blend may have a tensile elongation at break greater than or equal to 8% and less than or equal to 200%, greater than or equal to 8% and less than or equal to 150%, greater than or equal to 8% and less than or equal to 100%, greater than or equal to 15% and less than or equal to 200%, greater than or equal to 15% and less than or equal to 150%, greater than or equal to 15% and less than or equal to 100%, greater than or equal to 20% and less than or equal to 200%, greater than or equal to 20% and less than or equal to 150%, or even greater than or equal to 20% and less than or equal to 100%, or any and all sub-ranges formed from any of these endpoints.

In embodiments, the polymer blend may have a flexural strength greater than or equal to 50 MPa or even greater than or equal to 55 MPa. In embodiments, the polymer blend may have a flexural strength less than or equal to 85 MPa or even less than or equal to 80 MPa. In embodiments, the polymer blend may have a flexural strength greater than or equal to 50 MPa and less than or equal to 85 MPa, greater than or equal to 50 MPa and less than or equal to 80 MPa, greater than or equal to 55 MPa and less than or equal to 85 MPa, or even greater than or equal to 55 MPa and less than or equal to 80 MPa, or any and all sub-ranges formed from any of these endpoints.

In embodiments, the polymer blend may have a tensile modulus greater than or equal to 1600 MPa, a tensile strength at yield of greater than or equal to 35 MPa, a tensile strength at break greater than or equal to 35 MPa, a flexural modulus greater than or equal to 1900 MPa, and a flexural strength greater than or equal to 50 MPa.

Flame retardant increases the flame retardancy of the polymer blend as evidenced by the flammability rating. In embodiments, the polymer blend has a flammability rating of V-0 at a thickness of 3 mm as measured in accordance with UL 94. In embodiments, the polymer blend has a flammability rating of V-1 at a thickness of 1.5 mm as measured in accordance with UL 94. In embodiments, the polymer blend has a flammability rating of V-0 at a thickness of 1.5 mm as measured in accordance with UL 94. In embodiments, the polymer blend has a flammability rating of V-1 at a thickness of 0.75 mm as measured in accordance with UL 94. In embodiments, the polymer blend has a flammability rating of 5VA at a thickness of 3 mm as measured in accordance with UL 94. In embodiments, the polymer blend has a flammability rating of 5VA at a thickness of 1.5 mm as measured in accordance with UL 94.

As exemplified in the Examples section below, the aliphatic polyketone, ABS, and flame retardant blends described herein have improved chemical resistance and flame retardancy while providing improved heat resistance and sufficient tensile and flexural strength and stiffness. Accordingly, the aliphatic polyketone, ABS, and flame retardant blends may be more suitable for certain applications in the healthcare, automotive, and electronic fields in which chemical resistance and flame retardancy are desired.

Hydroxyapatite Stabilizer

In embodiments, the polymer blend may further comprise a hydroxyapatite stabilizer. While not wishing to be bound by theory, without a hydroxyapatite stabilizer present, the aliphatic polyketone may crosslink with itself resulting in significant increases in viscosity and, consequently, processing difficulties. When present in the polymer blend, the hydroxyapatite stabilizer acts as an acid scavenger, which prevents the aliphatic polyketone from self-reaction and crosslinking.

In embodiments, the hydroxyapatite stabilizer may comprise pentacalcium hydroxide tris(orthophosphate), amorphous tricalcium hydroxyphosphate, calcium phosphate hydroxide, or a combination thereof.

In embodiments, the amount of hydroxyapatite stabilizer in the polymer blend may be greater than 0 wt %, greater than or equal to 0.1 wt %, greater than or equal to 0.25 wt %, or even greater than or equal to 0.5 wt %. In embodiments, the amount of hydroxyapatite stabilizer in the polymer blend may be less than or equal to 1 wt % or even less than or equal to 0.75 wt %. In embodiments, the amount of hydroxyapatite stabilizer in the polymer blend may be greater than 0 wt % and less than or equal to 1 wt %, greater than 0 wt % and less than or equal to 0.75 wt %, greater than or equal to 0.25 wt % and less than or equal to 1 wt %, greater than or equal to 0.25 wt % and less than or equal to 0.75 wt %, greater than or equal to 0.5 wt % and less than or equal to 1 wt %, or even greater than or equal to 0.5 wt % and less than or equal to 0.75 wt %, or any and all sub-ranges formed from any of these endpoints.

In embodiments, the amount of P₂O₅ in the hydroxyapatite stabilizer may be greater than or equal to 30 wt % or even greater than or equal to 40 wt %. In embodiments, the amount of P₂O₅ in the hydroxyapatite stabilizer may be less than or equal to 60 wt % or even less than or equal to 50 wt %. In embodiments, the amount of P₂O₅ in the hydroxyapatite stabilizer may be greater than or equal to 30 wt % and less than or equal to 60 wt %, greater than or equal to 30 wt % and less than or equal to 50 wt %, greater than or equal to 40 wt % and less than or equal to 60 wt %, or even greater than or equal to 40 wt % and less than or equal to 50 wt %, or any and all sub-ranges formed from any of these endpoints.

In embodiments, the amount of CaO in the hydroxyapatite stabilizer may be greater than or equal to 40 wt % or even greater than or equal to 50 wt %. In embodiments, the amount of CaO in the hydroxyapatite stabilizer may be less than or equal to 70 wt % or even less than or equal to 60 wt %. In embodiments, the amount of CaO in the hydroxyapatite stabilizer may be greater than or equal to 40 wt % and less than or equal to 70 wt %, greater than or equal to 40 wt % and less than or equal to 60 wt %, greater than or equal to 50 wt % and less than or equal to 70 wt %, or even greater than or equal to 50 wt % and less than or equal to 60 wt %, or any and all sub-ranges formed from any of these endpoints.

In embodiments, the hydroxyapatite stabilizer may have a particle size D50 greater than or equal to 1 μm or even greater than or equal to 2 μm. In embodiments, the hydroxyapatite stabilizer may have a particle size distribution D50 less than or equal to 10 μm or even less than or equal to 5 μm. In embodiments, the hydroxyapatite stabilizer may have a particle size D50 greater than or equal to 1 μm and less than or equal to 10 μm, greater than or equal to 1 μm and less than or equal to 5 μm, greater than or equal to 2 μm and less than or equal to 10 μm, or even greater than or equal to 2 μm and less than or equal to 5 μm, or any and all sub-ranges formed from any of these endpoints

In embodiments, the hydroxyapatite stabilizer may have a loss on ignition greater than or equal to 2% or even greater than or equal to 4%. In embodiments, the hydroxyapatite stabilizer may have a loss on ignition less than or equal to 10% or even less than or equal to 5%. In embodiments, the hydroxyapatite stabilizer may have a loss on ignition greater than or equal to 2% and less than or equal to 10%, greater than or equal to 2% and less than or equal to 5%, greater than or equal to 4% and less than or equal to 10%, or even greater than or equal to 4% and less than or equal to 5%, or any and all sub-ranges formed from any of these endpoints.

Suitable commercial embodiments of the hydroxyapatite stabilizer are available under the as EPSOLUTE brand from Budenheim, such as grade C13-09. Table 4 shows certain properties of EPSOLUTE C13-09.

TABLE 4

| | EPSOLUTE C13-09 |
|---|---|
| P₂O₅ (wt %) | 40.0-42.0 |
| CaO (wt %) | 53.0-56.0 |
| Particle size (D50) (μm) | 2.9-3.4 |
| Loss on ignition (%) | 4.0 |

Rubber-Containing Impact Modifier

In addition to improved chemical resistance and flame retardancy, it may be desirable for the polymer blends described herein to exhibit sufficient impact strength, as evidenced by a Notched Izod Impact strength greater than or equal to 200 J/m and a peak energy greater than or equal to 30 J. Accordingly, in embodiments, a rubber-containing impact modifier may be added to the aliphatic polyketone and ABS blends described herein to increase the Notched Izod Impact strength and peak energy of the polymer blends.

In embodiments, the amount of rubber-containing impact modifier in the polymer blend may be greater than 0 wt %, greater than or equal to 3 wt %, greater than or equal to 5 wt %, greater than or equal to 7 wt %, or even greater than or equal to 10 wt %. In embodiments, the amount of rubber-containing impact modifier may be less than or equal to 20 wt %, less than or equal to 18 wt %, less than or equal to 16 wt %, less than or equal to 14 wt %, or even less than or equal to 12 wt %. In embodiments, the amount of rubber-containing impact modifier in the polymer blend may be greater 0 wt % and less than or equal to 20 wt %, greater than 0 wt % and less than or equal to 18 wt %, greater than 0 wt % and less than or equal to 16 wt %, greater than 0 wt % and less than or equal to 14 wt %, greater than 0 wt % and less than or equal to 12 wt %, greater than or equal to 3 wt % and less than or equal to 20 wt %, greater than or equal to 3 wt % and less than or equal to 18 wt %, greater than or equal to 3 wt % and less than or equal to 16 wt %, greater than or equal to 3 wt % and less than or equal to 14 wt %, greater than or equal to 3 wt % and less than or equal to 12 wt %, greater than or equal to 5 wt % and less than or equal to 20 wt %, greater than or equal to 5 wt % and less than or equal to 18 wt %, greater than or equal to 5 wt % and less than or equal to 16 wt %, greater than or equal to 5 wt % and less than or equal to 14 wt %, greater than or equal to 5 wt % and less than or equal to 12 wt %, greater than or equal to 7 wt % and less than or equal to 20 wt %, greater than or equal to 7 wt % and less than or equal to 18 wt %, greater than or equal to 7 wt % and less than or equal to 16 wt %, greater than or equal to 7 wt % and less than or equal to 14 wt %, greater than or equal to 7 wt % and less than or equal to 12 wt %, greater than or equal to 10 wt % and less than or equal to 20 wt %, greater than or equal to 10 wt % and less than or equal to 18 wt %, greater than or equal to 10 wt % and less than or equal to 16 wt %, greater than or equal to 10 wt % and less than or equal to 14 wt %, or even greater than or equal to 10 wt % and less than or equal to 12 wt %, or any and all sub-ranges formed from any of these endpoints.

In embodiments, the rubber-containing impact modifier may comprise another ABS, methyl methacrylate butadiene styrene (MBS), acrylonitrile styrene acrylate (ASA), or a combination thereof. In embodiments, the another ABS may be a high rubber (e.g., greater than 50 wt % butadiene) ABS.

In embodiments, the polymer blend may have a Notched Izod Impact strength greater than or equal to 200 J/m or even greater than or equal to 300 J/m. In embodiments, the polymer blend may have a Notched Izod Impact strength less than or equal to 600 J/m or even less than or equal to 500 J/m. In embodiments, the polymer blend may have a Notched Izod Impact strength greater than or equal to 200 J/m and less than or equal to 600 J/m, greater than or equal to 200 J/m and less than or equal to 500 J/m, greater than or equal to 300 J/m and less than or equal to 600 J/m, or even greater than or equal to 300 J/m and less than or equal to 500 J/m, or any and all sub-ranges formed from any of these endpoints.

In embodiments, the polymer blend may have an instrumented impact peak energy greater than or equal to 30 J, greater than or equal to 32 J, or even greater than or equal to 34 J. In embodiments, the polymer blend may have an instrumented impact peak energy less than or equal to 50 J or even less than or equal to 45 J. In embodiments, the polymer blend may have an instrumented impact peak energy greater than or equal to 30 J and less or equal to 50 J, greater than or equal to 30 J and less than or equal to 45 J, greater than or equal to 32 J and less or equal to 50 J, greater than or equal to 32 J and less than or equal to 45 J, greater than or equal to 34 J and less or equal to 50 J, or even greater than or equal to 34 J and less than or equal to 45 J, or any and all sub-ranges formed from any of these endpoints.

In embodiments, the polymer blend may exhibit a ductile break after being subjected to Instrumented Impact Testing according to ASTM D3763.

In embodiments, the rubber-containing impact modifier may have a melt flow rate greater than or equal to 1 g/10 min, greater than or equal to 3 g/10 min, or even greater than or equal to 5 g/10 min as measured in accordance with ASTM D1238 at 230° C. and a weight of 3.8 kg. In embodiments, the rubber-containing impact modifier may have a melt flow rate less than or equal to 20 g/10 min or even less than or equal to 10 g/10 min as measured in accordance with ASTM D1238 at 230° C. and a weight of 3.8 kg. In embodiments, the rubber-containing impact modifier may have a melt flow rate greater than or equal to 1 g/10 min and less than or equal to 20 g/10 min, greater than or equal to 1 g/10 min and less than or equal to 10 g/10 min, greater than or equal to 3 g/10 min and less than or equal to 20 g/10 min, greater than or equal to 3 g/10 min and less than or equal to 10 g/10 min, greater than or equal to 5 g/10 min and less than or equal to 20 g/10 min, or even greater than or equal to 5 g/10 min and less than or equal to 10 g/10 min, or any and all sub-ranges formed from any of these endpoints as measured in accordance with ASTM D1238 at 230° C. and a weight of 3.8 kg.

In embodiments, the rubber-containing impact modifier may have a specific gravity greater than or equal to 0.85 or even greater than or equal to 0.9. In embodiments, the rubber-containing impact modifier may have a specific gravity less than or equal to 1.05 or even less than or equal to 1. In embodiments the rubber-containing impact modifier may have a specific gravity greater than or equal to 0.85 and less than or equal to 1.05, greater than or equal to 0.85 and less than or equal to 1, greater than or equal to 0.9 and less than or equal to 1.05, or even greater than or equal to 0.9 and less than or equal to 1, or any and all sub-ranges formed from any of these endpoints.

In embodiments, the rubber-containing impact modifier may have a Shore D hardness greater than or equal to 20 or even greater than or equal to 30. In embodiments, the rubber-containing impact modifier may have a Shore D hardness less than or equal to 60 or even less than or equal to 50. In embodiments, the rubber-containing impact modifier may have a Shore D hardness greater than or equal to 20 and less than or equal to 60, greater than or equal to 20 and less than or equal to 50, greater than or equal to 30 and less than or equal to 60, or even greater than or equal to 30 and less than or equal to 50, or any and all sub-ranges formed from any of these endpoints.

Suitable commercial embodiments of the rubber-containing impact modifier are available under the BLENDEX brand from Galata Chemicals, such as grade 338, and under the CLEARSTRENGTH brand from Arkema, such as grade E-920. Table 5 shows certain properties of BLENDEX 338 and CLEARSTRENGTH E-920.

TABLE 5

| | BLENDEX | CLEARSTRENGTH |
|---|---|---|
| | 338 | E-920 |
| Melt flow rate (g/10 min) | 5.7 | — |
| (230° C./3.8 kg) | | |
| Specific gravity | 0.950 | 1.02 |
| Hardness (Shore D) | 40 | — |

As exemplified in the Examples section below, the addition of a rubber-containing impact modifier to an aliphatic polyketone, ABS, and flame retardant blends as described herein results in a polymer blend that exhibits chemical resistance, flame retardancy, and sufficient impact strength.

Compatibilizer

In addition to improved chemical resistance, it may be desirable to compatibilize the components of the polymer blend. Accordingly, in embodiments, a compatibilizer may be added to the aliphatic polyketone and ABS blends described herein. The compatibilizer may react with or be miscible with the aliphatic polyketone and/or ABS to alter the dissimilar phases and improve the interfacial compatibility of the polymer blend as evidenced by increased Notched Izod Impact strength and a shift in glass transition temperature determined by dynamic mechanical analysis.

In embodiments, the amount of compatibilizer in the polymer blend may be greater than 0 wt %, greater than or equal to 1 wt %, greater than or equal to 1.25 wt %, greater than or equal to 2 wt %, or even greater than or equal to 2.5 wt %. In embodiments, the amount of compatibilizer in the polymer blend may be less than or equal to 5 wt %, less than or equal to 4 wt %, or even less than or equal to 3 wt %. In embodiments, the amount of compatibilizer in the polymer blend may be greater than 0 wt % and less than or equal to 5 wt %, greater than 0 wt % and less than or equal to 4 wt %, greater than 0 wt % and less than or equal to 3 wt %, greater than or equal to 1 wt % and less than or equal to 5 wt %, greater than or equal to 1 wt % and less than or equal to 4 wt %, greater than or equal to 1 wt % and less than or equal to 3 wt %, greater than or equal to 1.25 wt % and less than or equal to 5 wt %, greater than or equal to 1.25 wt % and less than or equal to 4 wt %, greater than or equal to 1.25 wt % and less than or equal to 3 wt %, greater than or equal to 2 wt % and less than or equal to 5 wt %, greater than or equal to 2 wt % and less than or equal to 4 wt %, greater than or equal to 2 wt % and less than or equal to 3 wt %, greater than or equal to 2.5 wt % and less than or equal to 5 wt %, greater than or equal to 2.5 wt % and less than or equal to 4 wt %, or even greater than or equal to 2.5 wt % and less than or equal to 3 wt %, or any and all sub-ranges formed from any of these endpoints.

In embodiments, the compatibilizer may comprise styrene maleic anhydride (SMA), aromatic polyketone, maleated-ABS, polystyrene sulfonate, acrylic copolymers, or a combination thereof.

In embodiments, the compatibilizer may have a weight average molecular weight (Mw) greater than or equal to 4000 g/mol or even greater than or equal to 5000 g/mol. In embodiments, the compatibilizer may have a weight average molecular weight (Mw) less than or equal to 7000 g/mol or even less than or equal to 6000 g/mol. In embodiments, the compatibilizer may have a weight average molecular weight (Mw) greater than or equal to 4000 g/mol and less than or equal to 7000 g/mol, greater than or equal to 4000 g/mol and less than or equal to 6000 g/mol, greater than or equal to 5000 g/mol and less than or equal to 7000 g/mol, or even greater than or equal to 5000 g/mol and less than or equal to 6000 g/mol, or any and all sub-ranges formed from any of these endpoints.

In embodiments, the compatibilizer may have an acid value greater than or equal to 400 mg KOH/g or even greater than 450 mg KOH/g. In embodiments, the compatibilizer may have an acid value less than or equal to 550 mg KOH/g or even less than or equal to 500 mg KOH/g. In embodiments, the compatibilizer may have an acid value greater than or equal to 400 mg KOH/g and less than or equal to 550 mg KOH/g, greater than or equal to 400 mg KOH/g and less than or equal to 500 mg KOH/g, greater than or equal to 450 mg KOH/g and less than or equal to 550 mg KOH/g, or even greater than or equal to 450 mg KOH/g and less than or equal to 500 mg KOH/g.

In embodiments, the compatibilizer may have a glass transition temperature greater than or equal to 100° C. or even greater than or equal to 125° C. In embodiments, the compatibilizer may have a glass transition temperature less than or equal to 175° C. or even less than or equal to 150° C. In embodiments, the compatibilizer may have a glass transition temperature greater than or equal to 100° C. and less than or equal to 175° C., greater than or equal to 100° C. and less than or equal to 150° C., greater than or equal to 125° C. and less than or equal to 175° C., or even greater than or equal to 125° C. and less than or equal to 150° C., or any and all sub-ranges formed from any of these endpoints.

Suitable commercial embodiments of the compatibilizer are available under the XIBOND brand from Polyscope, such as grade 285; under the BONDYRAM brand from Polyram Group, such as 6000; under the METBLEN brand from Mitsubishi Chemical; and ethylene acrylate based terpolymers from Lotader. Table 6 shows certain properties of XIBOND 285.

TABLE 6

| | XIBOND 285 |
|---|---|
| Mw (g/mol) | 5000 |
| Acid value (mg KOH/g) | 480 |
| Glass transition temperature (° C.) | 130 |

Filler

In embodiments, the polymer blend may further comprise a filler. In embodiments, the filler may comprise adhesion promoters; biocides; anti-fogging agents; anti-static agents; blowing and foaming agents; bonding agents and bonding polymers; dispersants; flame retardants and smoke suppressants; impact modifiers; initiators; lubricants; micas; pigments, colorants, and dyes; processing aids; release agents; silanes, titanates, and zirconates; slip and anti-blocking agents; stearates; ultraviolet light absorbers; viscosity regulators; waxes; or combinations thereof.

In embodiments, the amount of filler in the polymer blend may be greater than 0 wt % or even greater than or equal to 0.1 wt %. In embodiments, the amount of the filler in the polymer blend may be less than or equal to 1 wt %, less than or equal to 0.75 wt %, or even less than or equal to 0.5 wt %. In embodiments, the amount of the filler in the polymer blend may be greater than 0 wt % and less than or equal to 1 wt %, greater than 0 wt % and less than or equal to 0.75 wt %, greater than 0 wt % and less than or equal to 0.5 wt %, greater than or equal to 0.1 wt % and less than or equal to 1 wt %, greater than or equal to 0.1 wt % and less than or equal to 0.75 wt %, or even greater than or equal to 0.1 wt % and less than or equal to 0.5 wt %, or any and all sub-ranges formed from any of these endpoints.

Suitable commercial embodiments of the filler are available under the IRGAFOS 168 brand from BASF, such as grade 168 and under the IRGANOX brand from BASF, such as grade 1098 and 1010.

Processing

In embodiments, the polymer blend described herein may be made with batch process or continuous process.

In embodiments, the components of the polymer blend may be added all together in an extruder and mixed. In embodiments, mixing may be a continuous process at an elevated temperature (e.g., 230° C.-275° C.) that is sufficient to melt the polymer matrix. In embodiments, fillers may be added at the feed-throat, or by injection or side-feeders downstream. In embodiments, the output from the extruder is pelletized for later extrusion, molding, thermoforming, foaming, calendaring, and/or other processing into polymeric articles.

### Examples

Table 7 shows sources of ingredients for the polymer blends of Examples 1-4.

TABLE 7

| Ingredient | Brand | Source |
|---|---|---|
| aliphatic polyketone | POKETONE M630A | Hyosung Polyketone |
| aliphatic polyketone | POKETONE M630P | Hyosung Polyketone |
| ABS | LUSTRAN 348 | INEOS Styrolution |
| ABS | LUSTRAN 433 | INEOS Styrolution |
| hydroxyapatite stabilizer | EPSOLUTE C13-09 | Budenheim |
| (tricalcium phosphate) | | |
| flame retardant | EXOLIT OP 1230 | Clariant |
| (phosphinate) | | |
| rubber-containing impact | BLENDEX 338 | Galata Chemicals |
| modifier (high rubber ABS) | | |
| antioxidant | IRGAFOS 168 | BASF |
| antioxidant | IRGANOX 1098 | BASF |

Method of Environmental Stress Cracking (ESCR)

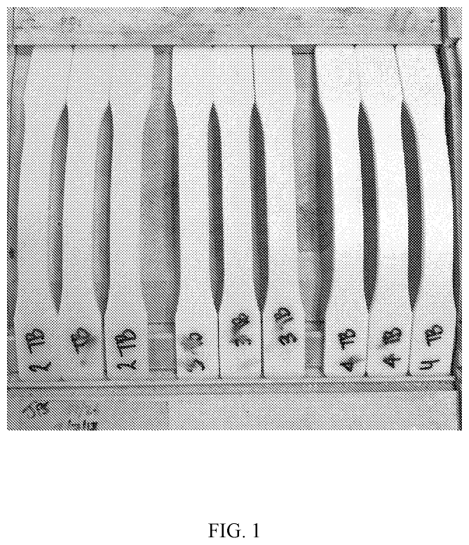

Sample bars having the formulations of the Examples shown in Tables 9 and 10 are formed. To decouple the effect of strain from the exhibited chemical resistance of the Example formulations, the sample bars are placed in a strain jig and subjected to a fixed strain as shown in FIG. 1. For the “1% Strain Control” examples, the sample bars are put under strain for a period of 72 hours. The tensile modulus, tensile strength at yield, and tensile elongation at yield of the strained control sample bars are measured and shown in Tables 9 and 10. For the other examples, the sample bars are put under strain and exposed to a chemical for 72 hours. The sample bars are exposed to a chemical by placing a gauze pad that has been soaked in the chemical on the sample bar, letting the gauze pad sit on the sample bar for 24 hours, removing the gauze pad, and placing a newly soaked gauze pad on the sample bar. This is repeated two more times. The tensile modulus, tensile strength at yield, and tensile elongation at yield of the chemically exposed sample bars are measured and shown in Tables 9 and 10. The tensile modulus retention, tensile strength at yield retention, and the tensile elongation at yield retention of the chemically exposed sample bars are calculated relative to the strained control sample bars and shown in Tables 9 and 10. A formulation is considered to have “good chemical resistance” when the property retentions for tensile modulus, tensile strength at yield, and tensile elongation property retention are between 90% and 110%. A formulation is considered to have “superior chemical resistance” when the property retentions for tensile modulus, tensile strength at yield, and tensile elongation at yield are between 95% and 105%. A formulation is considered to have “inferior chemical resistance” when any of the property retentions for tensile modulus, tensile strength at yield, and tensile elongation at yield are less than 90% or greater than 110%.

Table 8 shows the chemicals used in the ESCR testing.

TABLE 8

| Ingredients | Brand | Source |
|---|---|---|
| diethylene glycol butyl ether, N-alkyl | VIREX TB | Diversey |
| dimethyl benzyl ammonium chloride, and N- | | |
| alkyl dimethyl ethylbenzyl ammonium | | |
| chloride | | |
| isopropanol, 2-butoxyethanol, and | CAVICIDE | Metrex |
| diisobutylphenozyethoxyethyldimethylbenzyl | | |
| ammonium chloride | | |
| 1,2-benzenedicarboxyaldehyde | CIDEX OPA | American |
| | | Sterilization |
| | | Products |

Table 9 shows the formulation (in wt %), certain properties, flammability test results, and ESCR results of Example 1.

TABLE 9

| Example | 1 |
|---|---|
| Ratio of POKETONE M630A to | 2.3:1 |
| LUSTRAN 433 | |
| POKETONE M630A | 58.87 |
| POKETONE M630P | 5 |
| LUSTRAN 433 | 25.23 |
| EXOLIT OP1230 | 10 |
| EPSOLUTE C13-09 | 0.5 |
| IRGANOX 1098 | 0.25 |
| IRGAFOS 168 | 0.15 |
| Heat deflection temp. (° C.) | 111 |
| Tensile modulus (MPa) | 2196 |
| Tensile strength at yield (MPa) | 43 |
| Tensile elongation at yield (%) | 10 |
| Tensile strength at break (MPa) | 41 |
| Tensile elongation at break (%) | 50 |
| Flexural modulus (MPa) | 2118 |
| Flexural strength (MPa) | 69 |

Flammability Test

| | |
|---|---|
| Flammability Rating | V-1 |
| (1.5 mm thickness; 20 mm flame) | |
| Flammability Rating | V-0 |
| (3.0 mm thickness; 20 mm flame) | |

ESCR (1% Strain Control)

| | |
|---|---|
| Tensile modulus (MPa) | 915 |
| Tensile strength at yield (MPa) | 43 |
| Tensile elongation at yield (%) | 26.7 |

ESCR (VIREX TB)

| | |
|---|---|
| Tensile modulus (MPa) | 903 |
| Tensile modulus retention | 99 |
| (% relative to strain control) | |
| Tensile strength at yield (MPa) | 43 |
| Tensile strength at yield retention | 99 |
| (% relative to strain control) | |
| Tensile elongation at yield (%) | 27.5 |
| Tensile strength at elongation retention | 103 |
| (% relative to strain control) | |

ESCR (CAVICIDE)

| | |
|---|---|
| Tensile modulus (MPa) | 939 |
| Tensile modulus retention | 103 |
| (% relative to strain control) | |
| Tensile strength at yield (MPa) | 44 |
| Tensile strength at yield retention | 101 |
| (% relative to strain control) | |
| Tensile elongation at yield (%) | 26.8 |
| Tensile strength at elongation retention | 100 |
| (% relative to strain control) | |

ESCR (CIDEX OPA)

| | |
|---|---|
| Tensile modulus (MPa) | 907 |
| Tensile modulus retention | 99 |
| (% relative to strain control) | |
| Tensile strength at yield (MPa) | 43 |
| Tensile strength at yield retention | 100 |
| (% relative to strain control) | |
| Tensile elongation at yield (%) | 27.0 |
| Tensile strength at elongation retention | 101 |
| (% relative to strain control) | |

As shown in Table 9, Example 1 (2.3:1 POKETONE M630A (aliphatic polyketone) to LUSTRAN 433 (ABS) polymer blend including EXOLIT OP1230 (flame retardant)) has a heat deflection temperature of 111° C. and superior chemical resistance against VIREX TB, CAVICIDE, and CIDEX OPA. Example 1 has sufficient tensile and flexural strength and stiffness with a tensile modulus of 2196 MPa, a tensile strength at yield of 43 MPa, a tensile strength at break of 41 MPa, a flexural modulus of 2118 MPa, and a flexural strength of 69 MPa. In addition to having the increased heat deflection temperature, sufficient tensile and flexural strength and stiffness, and chemical resistance, Example 1 has a V-1 flammability rating at 1.5 mm thickness and a V-0 flammability rating at a 3.0 mm thickness.

As indicated by Example 1 shown in Table 9, a polymer blend of aliphatic polyketone, ABS, and flame retardant exhibits increased chemical resistance and flame retardancy.

Table 10 shows the formulation (in wt %), certain properties, flammability test results, and ESCR results of Examples 2-4.

TABLE 10

| Examples | 2 | 3 | 4 |
|---|---|---|---|
| Ratio of POKETONE M630A to | 2.3:1 | 3.5:1 | 4.7:1 |
| LUSTRAN 348 | | | |
| POKETONE M630A | 60.655 | 60.655 | 58.905 |
| LUSTRAN 348 | 25.995 | 17.33 | 12.6225 |
| BLENDEX 338 | 0 | 8.665 | 12.6225 |
| EXOLIT OP1230 | 12.5 | 12.5 | 15 |
| EPSOLUTE C13-09 | 0.5 | 0.5 | 0.5 |
| IRGANOX 1098 | 0.25 | 0.25 | 0.25 |
| IRGAFOS 168 | 0.1 | 0.1 | 0.1 |
| Notched Izod Impact strength (J/m) | 96 | 241 | 380 |
| Type of notched break | Complete | Partial | Partial |
| Instrumented impact peak energy (J) | 2 | 34 | 31 |
| Type instrumented impact break | Brittle | Brittle | Ductile |
| Heat deflection temp. (° C.) | 119 | 129 | 109 |
| Tensile modulus (MPa) | 1888 | 1715 | 1643 |
| Tensile strength at yield (MPa) | 43 | 41 | 40 |
| Tensile elongation at yield (%) | 12 | — | — |
| Tensile strength at break (MPa) | 39 | 40 | 39 |
| Tensile elongation at break (%) | 43 | 80 | 78 |
| Flexural modulus (MPa) | 2305 | 1993 | 1959 |
| Flexural strength (MPa) | 69 | 58 | 54 |

Flammability Test

| | | | |
|---|---|---|---|
| Flammability Rating | V-1 | V-1 | V-1 |
| (0.75 mm thickness; 20 mm flame) | | | |
| Flammability Rating | V-0 | V-0 | V-0 |
| (1.5 mm thickness; 20 mm flame) | | | |
| Flammability Rating | V-0 | V-0 | V-0 |
| (3 mm thickness; 20 mm flame) | | | |
| Flammability Rating | 5VA | — | — |
| (1.5 mm thickness; 125 mm flame) | | | |
| Flammability Rating | 5VA | — | — |
| (3 mm thickness; 125 mm flame) | | | |

ESCR (1% Strain Control)

| | | | |
|---|---|---|---|
| Tensile modulus (MPa) | 2075 | 1796 | 1743 |
| Tensile strength at yield (MPa) | 43 | 32* | 31* |
| Tensile elongation at yield (%) | 12 | 3.9* | 3.8* |

ESCR (VIREX TB)

| | | | |
|---|---|---|---|
| Tensile modulus (MPa) | 2055 | 1851 | 1902 |
| Tensile modulus retention | 99 | 103 | 109 |
| (% relative to strain control) | | | |
| Tensile strength at yield (MPa) | 43 | 32* | 32* |
| Tensile strength at yield retention | 99 | 99 | 102 |
| (% relative to strain control) | | | |
| Tensile elongation at yield (%) | 13 | 3.8* | 3.7* |
| Tensile strength at elongation retention | 106 | 99 | 97 |
| (% relative to strain control) | | | |

ESCR (CAVICIDE)

| | | | |
|---|---|---|---|
| Tensile modulus (MPa) | 2048 | 1803 | 1856 |
| Tensile modulus retention | 99 | 100 | 106 |
| (% relative to strain control) | | | |
| Tensile strength at yield (MPa) | 43 | 33* | 31* |
| Tensile strength at yield retention | 99 | 101 | 101 |
| (% relative to strain control) | | | |
| Tensile elongation at yield (%) | 13 | 3.9* | 3.7* |
| Tensile strength at elongation retention | 102 | 101 | 97 |
| (% relative to strain control) | | | |

ESCR (CIDEX OPA)

| | | | |
|---|---|---|---|
| Tensile modulus (MPa) | 1997 | 1849 | 1811 |
| Tensile modulus retention | 96 | 103 | 104 |
| (% relative to strain control) | | | |
| Tensile strength at yield (MPa) | 43 | 32* | 32* |
| Tensile strength at yield retention | 99 | 103 | 103 |
| (% relative to strain control) | | | |
| Tensile elongation at yield (%) | 13 | 3.9* | 3.8* |
| Tensile strength at elongation retention | 105 | 100 | 100 |
| (% relative to strain control) | | | |

*Values based on a 2% offset strain as measured in accordance with ASTM D638.

Example 2 (2.3:1 POKETONE M630A (aliphatic polyketone) to LUSTRAN 348 (ABS) polymer blend including EXOLIT OP1230 (flame retardant)) has a heat deflection temperature of 119° C., has superior chemical resistance against CAVICIDE and CIDEX OPA, and has good chemical resistance against VIREX TB. Example 2 has sufficient tensile and flexural strength and stiffness with a tensile modulus of 1888 MPa, a tensile strength at yield of 39 MPa, a tensile strength at break of 39 MPa, a flexural modulus of 2305 MPa, and a flexural strength of 69 MPa.

Example 3 (3.5:1 POKETONE M630A (aliphatic polyketone) to LUSTRAN 348 (ABS) polymer blend including EXOLIT OP1230 (flame retardant)) has a heat deflection temperature of 129° C. and superior chemical resistance against VIREX TB, CAVICIDE, and CIDEX OPA. Example 3 has sufficient tensile and flexural strength and stiffness with a tensile modulus of 1715 MPa, a tensile strength at yield of 41 MPa, a tensile strength at break of 40 MPa, a flexural modulus of 1993 MPa, and a flexural strength of 58 MPa.

Example 4 (4.7:1 POKETONE M630A (aliphatic polyketone) to LUSTRAN 348 (ABS) polymer blend including EXOLIT OP1230 (flame retardant)) has a heat deflection temperature of 109° C., has superior chemical resistance against CIDEX OPA and good chemical resistance against VIREX TB and CAVICIDE. Example 4 has sufficient tensile and flexural strength and stiffness with a tensile modulus of 1643 MPa, a tensile strength at yield of 40 MPa, a tensile strength at break of 39 MPa, a flexural modulus of 1959 MPa, and a flexural strength of 54 MPa.

In addition to having increased heat deflection temperature, sufficient tensile and flexural strength and stiffness, and chemical resistance, Examples 2-4 have increased flame retardancy as evidence by a V-1 flammability rating at 0.75 mm thickness, a V-0 flammability rating at 1.5 mm thickness, and a V-0 flammability rating at 3 mm thickness. Example 2 has a 5VA flammability rating at a thickness of 1.5 mm and at a thickness of 3 mm.

As shown in Table 10, as the amount of BLENDEX 338 (rubber-containing impact modifier) is increased from 0 wt % of Example 2 to 8.665 wt % in Example 3 and 12.6225% in Example 4, the Notched Izod Impact strength increases to 241 J/m in Example 3 and 380 J/m in Example 4. Additionally, the increase in the amount of BLENDEX 338 increases the peak energy from 2 J in Example 2 to 34 J in Example 3 and 31 J in Example 4. And, with 12.6225 wt % BLENDEX 338, Example 4 exhibits a ductile break.

As indicated by Examples 2-4 shown in Table 10, the addition of a rubber-containing modifier to a polymer blend of aliphatic polyketone, ABS, and flame retardant as described herein results in a polymer blend that exhibits increased chemical resistance, flame retardancy, and sufficient impact strength.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

1. A polymer blend comprising:
greater than or equal to 45 wt % and less than or equal to 90 wt % of an aliphatic polyketone;
greater than or equal to 7.5 wt % and less than or equal to 40 wt % of an acrylonitrile butadiene styrene (ABS); and
greater than 0 wt % and less than or equal to 25 wt % of a flame retardant.

2. The polymer blend of claim 1, wherein the aliphatic polyketone has a melt flow rate greater than or equal to 1 g/10 min and less than or equal to 90 g/10 min as measured in accordance with ASTM D1238 at 240° C. and a weight of 2.16 kg.

3. The polymer blend of claim 2, wherein the aliphatic polyketone has a melt flow rate greater than or equal to 1 g/10 min and less than or equal to 20 g/10 min as measured in accordance with ASTM D1238 at 240° C. and a weight of 2.16 kg.

4. The polymer blend of claim 2, wherein the aliphatic polyketone has a melt flow rate greater than or equal to 40 g/10 min and less than or equal to 90 g/10 min as measured in accordance with ASTM D1238 at 240° C. and a weight of 2.16 kg.

5. The polymer blend of claim 1, wherein the polymer blend further comprises greater than 0 wt % and less than or equal to 1 wt % of a hydroxyapatite stabilizer.

6. The polymer blend of claim 5, wherein the hydroxyapatite stabilizer is pentacalcium hydroxide tris(orthophosphate), amorphous tricalcium hydroxyphosphate, calcium phosphate hydroxide, or a combination thereof.

7. The polymer blend of claim 1, wherein the polymer blend comprises greater than or equal to 60 wt % and less than or equal to 80 wt % of the aliphatic polyketone; greater than or equal to 20 wt % and less than or equal to 40 wt % of the ABS; and greater than or equal to 2.5 wt % and less than or equal to 20 wt % of the flame retardant.

8. (canceled)

9. (canceled)

10. (canceled)

11. (canceled)

12. The polymer blend of claim 1, wherein the polymer blend has a heat deflection temperature greater than or equal to 100° C. as measured in accordance with ASTM D648 at a 0.45 MPa load.

13. (canceled)

14. (canceled)

15. (canceled)

16. (canceled)

17. (canceled)

18. The polymer blend of claim 1, wherein the polymer blend has a tensile modulus greater than or equal to 1600 MPa as measured in accordance with ASTM D638 at 23° C. and a rate of strain of 0.85 mm/s, a tensile strength at yield greater than or equal to 35 MPa as measured in accordance with ASTM D638 at 23° C. and a rate of strain of 0.85 mm/s, a tensile strength at break greater than or equal to 35 MPa as measured in accordance with ASTM D638 at 23° C. and a rate of strain of 0.85 mm/s, a flexural modulus greater than or equal to 1900 MPa as measured in accordance with ASTM D790 at 23° C. and a rate of strain 0.21 mm/s, and a flexural strength greater than or equal to 50 MPa as measured in accordance with ASTM D790 at 23° C. and a rate of strain 0.21 mm/s.

19. The polymer blend of claim 1, wherein the polymer blend has a flammability rating of V-0 at a thickness of 3 mm as measured in accordance with UL 94.

20. The polymer blend of claim 1, wherein the polymer blend has a flammability rating of V-1 at a thickness of 1.5 mm as measured in accordance with UL 94.

21. The polymer blend of claim 1, wherein the polymer blend has a flammability rating of V-0 at a thickness of 1.5 mm as measured in accordance with UL 94.

22. The polymer blend of claim 1, wherein the polymer blend has a flammability rating of V-1 at a thickness of 0.75 mm as measured in accordance with UL 94.

23. The polymer blend of claim 1, wherein the polymer blend has a flammability rating of 5VA at a thickness of 3 mm as measured in accordance with UL 94.

24. The polymer blend of claim 1, wherein the polymer blend has a flammability rating of 5VA at a thickness of 1.5 mm as measured in accordance with UL 94.

25. The polymer blend of claim 1, wherein the polymer blend further comprises greater than 0 wt % and less than or equal to 20 wt % of a rubber-containing impact modifier.

26. (canceled)

27. The polymer blend of claim 25, wherein the polymer blend has a Notched Izod Impact strength greater than or equal to 200 J/m.

28. The polymer blend of claim 25, wherein the polymer blend has a peak energy greater than or equal to 30 J as measured in accordance with ASTM D3763.

29. The polymer blend of claim 1, wherein the polymer blend further comprises greater than 0 wt % and less than or equal to 5 wt % of a compatibilizer.

30. (canceled)
